(19) United States
(12) Patent Application Publication
(10) Pub. No.: US 2012/0281416 A1
(43) Pub. Date: Nov. 8, 2012

(54) Optical Lenses and Lamps Containing Said Optical Lenses

(75) Inventors: Ling-Yu Tsai, New Taipei City (TW); Fu-Jay Juang, New Taipei City (TW)

(73) Assignee: EVERLIGHT ELECTRONICS CO., LTD., New Taipei City (TW)

(21) Appl. No.: 13/463,815

(22) Filed: May 4, 2012

(30) Foreign Application Priority Data
May 5, 2011 (CN) 201110114929.3

(51) Int. Cl. F21V 5/04; F21V 29/00

(52) U.S. Cl. 362/294; 362/335

(57) ABSTRACT

An optical lens and a lamp containing such optical lens suitable for use in commercial refrigerators are provided. The lamp has an overall long shape. The optical lens produces a bat-wing type of lighting distribution. The optical lens comprises a light incident surface and a light exit surface. The light incident surface comprises a sawtooth-like structure having a plurality of sawtooth-like protrusions. Each of the sawtooth-like protrusions respectively comprises a peak, and a respective valley exists between every two neighboring sawtooth-like protrusions. The distances between the light exit surface and the valleys between every respective two neighboring sawtooth-like protrusions are approximately the same. The sawtooth-like structure of the optical lens helps produce the bat-wing type of lighting distribution. The thickness is generally uniform throughout the optical lens. The optical lens can be manufactured by the extrusion process and has advantages comprising continuous production, high efficiency, simple operation and low cost.

### CROSS-REFERENCE TO RELATED APPLICATION

This application claims the priority benefit of China Patent Application No. 201110114929.3, filed on May 5, 2011. The entirety of the above-identified patent application is hereby incorporated by reference and made a part of this specification.

### BACKGROUND

1. Technical Field

The present invention relates to optical lenses and lamps containing said optical lenses and, more particularly, to optical lenses for refrigerator lighting that generate and distribute lighting in the shape of a bat wing.

2. Description of Related Art

There exist many types of commercial refrigerators that are used in supermarkets and other kinds of commercial facilities. In order to allow consumers to see the merchandise stored therein, commercial refrigerators typically are equipped with glass door(s) or transparent side wall(s). Commercial refrigerators typically are also equipped with a light source to illuminate the merchandise stored therein. Given the limitation in storage volume, a distance between the light source and stored merchandise tends to be short. If an ordinary fluorescent lamp is used as the light source, lighting at locations in a commercial refrigerator near the light source generally tends to be stronger while lighting at locations in the commercial refrigerator further away from the light source generally tends to be weaker, thus resulting in non-uniform illumination. An approach to rectify this situation is to install an optical lens outside the fluorescent lamp to direct the light emitted by the light source towards two sides, resulting in a lighting shape having the strongest light intensity on two sides of the light source. This type of lighting distribution is referred to as bat-wing type of lighting distribution where an angle between the strongest light intensities on the two sides is known as the beam angle.

Fluorescent lamps are a type of low-pressure mercury vapor arc discharge lamps. Electrical energy consumed during the gas discharge is primarily converted into electromagnetic radiation in the ultraviolet range with approximately 3% of the energy directly converted into visible light. Ultraviolet radiation exposure of the phosphor coating on the tube wall of the fluorescent lamp results in absorption of the ultraviolet energy by the fluorescent material with some of the energy converted into and released as visible light. The visible light emitted from a typical fluorescent lamp comprises light from the fluorescent coating and light from gas discharge, and amounts to approximately 28% of the energy supplied to the fluorescent lamp. Moreover, a fluorescent lamp typically has a relatively large size, requires a complex drive circuit to provide high voltage to light up the lamp, and generates heat during operation. When a fluorescent lamp is used in the commercial refrigerator application it is installed inside the commercial refrigerator. However, the heat generated by the fluorescent lamp would directly dissipate inside the commercial refrigerator. This undesirably increases the loading on the cooling system of the commercial refrigerator and increases energy consumption.

Light emitting diodes (LED) are a type of solid state semiconductor devices that convert electrical energy into visible light. Rather than emitting light with a tungsten filament as in incandescent lamps or trichromatic phosphor luminescence as in fluorescent lamps, LEDs emit light based on electric field. Advantages of LED lighting include, for example, long lifespan, high luminous efficiency, no radiation and low energy consumption. As LEDs are a type of cold light source, the spectrum of the emitted light does not include infrared. Accordingly, compared to fluorescent lamps, LEDs are a better light source for commercial refrigerators.

However, intensity of the light emitted from an LED is the strongest around a central axis of the emitted beam of light while the intensity gradually decreases towards two sides. An LED lamp is typically equipped with an optical lens to distribute the emitted light in the shape of a bat airfoil for the commercial refrigerator application. As shown in FIGS. 1 and 2, each of optical lenses 10 and 11 is shaped to be thin in the center and thick on the sides. Optical lenses 10 and 11 are generally made by the use of molding, but the production efficiency is not very high and the cost is relatively high. Extrusion is another plastics processing method that can be used to manufacture optical lenses. As extrusion provides several advantages such as continuous production, high efficiency, simple operation and low cost, it has been widely used in plastics processing.

The principle of operation of extrusion comprises a number of steps. A screw of a particular shape rotates in a heated barrel and presses forward plastic material that is fed into the barrel from a hopper to allow the plastics to melt evenly. The melted plastic material is extruded through a nozzle and molds of different shapes to produce a continuous plastic layer of various shapes.

When the melted plastic material is extruded, the plastic material in the hopper enters the barrel by gravity or a feeding spiral and is pushed forward by the rotating screw. The plastic material turns into a viscous flow state as it is stirred and pressed by the rotating screw and, meanwhile, subject to external heat from the barrel as well as frictional heat from shears between the plastics and the equipment. Subsequently it forms a continuous material flow in a drop slot. The plasticized material is pushed through the nozzle and extruded through a molding opening, and then is cooled to solidify.

Contraction may occur during the forming process due to material property. The complexity of the product shape and difference in geometry and wall thickness may contribute to difference in the rate of contraction. Moreover, as variation in size due to extrusion is related to the structural shape and wall thickness of the final product, wall thickness throughout the final product should be as uniform as possible.

Accordingly, in optical lenses that produce bat-wing type of lighting distribution, such as optical lenses 10 and 11 shown in FIGS. 1 and 2, the lens tends to be thinner in the center and thicker on the sides. This, however, tends to cause the plastic material to migrate towards locations with larger wall thickness, thus making it difficult to manufacture using the extrusion method.

### SUMMARY

An objective of the present invention is to provide an optical lens that produces a bat-wing type of lighting distribution and can be manufactured by the extrusion method, as well as lamps having such optical lenses. Advantages of the present invention include, for example, continuous production, high efficiency, simple operation and low cost.

According to one aspect, an optical lens is overall long in shape and configured to produce a bat-wing type of lighting distribution. The optical lens may comprise a light exit surface and a light incident surface. The light incident surface may comprise a sawtooth-like structure having a plurality of sawtooth-like protrusions. Each of the sawtooth-like protrusions may include a respective peak. Every two neighboring sawtooth-like protrusions of the plurality of sawtooth-like protrusions may form a respective valley of a plurality of valleys including a first valley and a second valley. A first distance between the light exit surface and the first valley may be approximately equal to a second distance between the light exit surface and the second valley.

In one embodiment, the respective peak of each sawtooth-like protrusion may be sleek and smooth, and the respective valley between every two neighboring sawtooth-like protrusions of the plurality of sawtooth-like protrusions may be sleek and smooth.

In one embodiment, the light incident surface may comprise a light incident surface center. The plurality of sawtooth-like protrusions may comprise a first group of sawtooth-like protrusions and a second group of sawtooth-like protrusions symmetrically distributed on two sides of the light incident surface center. A respective peak of each sawtooth-like protrusion of the first group of sawtooth-like protrusions and the second group of sawtooth-like protrusions may be tilted in a respective direction that is away from the light incident surface center.

In one embodiment, a respective tilt angle of each sawtooth-like protrusion of the first group of sawtooth-like protrusions and the second group of sawtooth-like protrusions may decrease correspondingly as a distance between the respective sawtooth-like protrusion and the light incident surface center increases.

In one embodiment, the plurality of sawtooth-like protrusions may further comprises a third group of sawtooth-like protrusions disposed adjacent to the first group of sawtooth-like protrusions and a fourth group of sawtooth-like protrusions disposed adjacent to the second group of sawtooth-like protrusions. A respective peak of each sawtooth-like protrusion of the third group of sawtooth-like protrusions and the fourth group of sawtooth-like protrusions may be tilted in a respective direction that is away from the light incident surface center. The third group of sawtooth-like protrusions may be farther away from the light incident surface center than the first group of sawtooth-like protrusions are. The fourth group of sawtooth-like protrusions may be farther away from the light incident surface center than the second group of sawtooth-like protrusions are.

In one embodiment, a respective tilt angle of each sawtooth-like protrusion of the third group of sawtooth-like protrusions and the fourth group of sawtooth-like protrusions may increase correspondingly as a distance between the respective sawtooth-like protrusion and the light incident surface center increases.

In one embodiment, a cross section of the optical lens may be arched in shape or flat in shape.

According to another aspect, a lamp may comprise a light source device, a heat dissipation device, a circuit module, and a lamp shell in which the light source device, the heat dissipation device and the circuit module are disposed. The lamp shell may have an overall long shape and a generally ring-shaped cross section. The lamp shell may comprise an upper portion and a lower portion. The upper portion of the lamp shell may comprise an optical lens having a cross section arched in shape and configured to produce a bat-wing type of lighting distribution. The optical lens may include a light incident surface that faces the light source device.

In one embodiment, the optical lens may comprise a light exit surface and the light incident surface. The light incident surface may comprise a sawtooth-like structure having a plurality of sawtooth-like protrusions. Each of the sawtooth-like protrusions may have a respective peak and every two neighboring sawtooth-like protrusions of the plurality of sawtooth-like protrusions may form a respective valley such that a first distance between the light exit surface and a first valley is approximately equal to a second distance between the light exit surface and a second valley.

In one embodiment, the respective peak of each sawtooth-like protrusion may be sleek and smooth. The respective valley between every two neighboring sawtooth-like protrusions of the plurality of sawtooth-like protrusions may be sleek and smooth.

In one embodiment, the light incident surface may comprise a light incident surface center. The plurality of sawtooth-like protrusions may comprise a first group of sawtooth-like protrusions and a second group of sawtooth-like protrusions symmetrically distributed on two sides of the light incident surface center. A respective peak of each sawtooth-like protrusion of the first group of sawtooth-like protrusions and the second group of sawtooth-like protrusions may be tilted in a respective direction that is away from the light incident surface center.

In one embodiment, a respective tilt angle of each sawtooth-like protrusion of the first group of sawtooth-like protrusions and the second group of sawtooth-like protrusions may decrease correspondingly as a distance between the respective sawtooth-like protrusion and the light incident surface center increases.

In one embodiment, the plurality of sawtooth-like protrusions may further comprises a third group of sawtooth-like protrusions disposed adjacent to the first group of sawtooth-like protrusions and a fourth group of sawtooth-like protrusions disposed adjacent to the second group of sawtooth-like protrusions. A respective peak of each sawtooth-like protrusion of the third group of sawtooth-like protrusions and the fourth group of sawtooth-like protrusions may be tilted in a respective direction that is away from the light incident surface center. The third group of sawtooth-like protrusions may be farther away from the light incident surface center than the first group of sawtooth-like protrusions are. The fourth group of sawtooth-like protrusions may be farther away from the light incident surface center than the second group of sawtooth-like protrusions are.

In one embodiment, a respective tilt angle of each sawtooth-like protrusion of the third group of sawtooth-like protrusions and the fourth group of sawtooth-like protrusions may increase correspondingly as a distance between the respective sawtooth-like protrusion and the light incident surface center increases.

According to yet another aspect, a lamp may comprise a light source device, a heat dissipation device, a circuit module, a lamp shell, and an optical lens. The light source device, the heat dissipation device and the circuit module may be disposed in the lamp shell. The lamp shell may have an overall long shape and a generally ring-shaped cross section. The optical lens may have a cross section flat in shape and disposed between the light source device and the lamp shell. The optical lens may be configured to produce a bat-wing type of lighting distribution, and may include a light incident surface that faces the light source device.

In one embodiment, the optical lens may comprise a light exit surface and the light incident surface. The light incident surface may comprise a sawtooth-like structure having a plurality of sawtooth-like protrusions. Each of the sawtooth-like protrusions may have a respective peak and every two neighboring sawtooth-like protrusions of the plurality of sawtooth-like protrusions may form a respective valley such that a first distance between the light exit surface and a first valley is approximately equal to a second distance between the light exit surface and a second valley.

In one embodiment, the respective peak of each sawtooth-like protrusion may be sleek and smooth. The respective valley between every two neighboring sawtooth-like protrusions of the plurality of sawtooth-like protrusions may be sleek and smooth.

In one embodiment, the light incident surface may comprise a light incident surface center. The plurality of sawtooth-like protrusions may comprise a first group of sawtooth-like protrusions and a second group of sawtooth-like protrusions symmetrically distributed on two sides of the light incident surface center. A respective peak of each sawtooth-like protrusion of the first group of sawtooth-like protrusions and the second group of sawtooth-like protrusions may be tilted in a respective direction that is away from the light incident surface center.

In one embodiment, a respective tilt angle of each sawtooth-like protrusion of the first group of sawtooth-like protrusions and the second group of sawtooth-like protrusions may decrease correspondingly as a distance between the respective sawtooth-like protrusion and the light incident surface center increases.

In one embodiment, the plurality of sawtooth-like protrusions may further comprise a third group of sawtooth-like protrusions disposed adjacent to the first group of sawtooth-like protrusions and a fourth group of sawtooth-like protrusions disposed adjacent to the second group of sawtooth-like protrusions. A respective peak of each sawtooth-like protrusion of the third group of sawtooth-like protrusions and the fourth group of sawtooth-like protrusions may be tilted in a respective direction that is away from the light incident surface center. The third group of sawtooth-like protrusions may be farther away from the light incident surface center than the first group of sawtooth-like protrusions are. The fourth group of sawtooth-like protrusions may be farther away from the light incident surface center than the second group of sawtooth-like protrusions are.

In one embodiment, a respective tilt angle of each sawtooth-like protrusion of the third group of sawtooth-like protrusions and the fourth group of sawtooth-like protrusions may increase correspondingly as a distance between the respective sawtooth-like protrusion and the light incident surface center increases.

With respect to the optical lens of the present invention, when light emitted by the light source device is incident on the sawtooth-like structure of the light incident surface a bat-wing type of lighting distribution can result after the light is refracted by the sawtooth-like protrusions. As the distance from the valley between two neighboring sawtooth-like protrusions to the light exit surface is approximately the same from one valley to another, the overall thickness of the optical lens is basically uniform throughout. The optical lens can be manufactured by extrusion, which provides the benefits of continuous production, high efficiency, simple operation and low cost. Moreover, the fact that the peaks and valleys of the sawtooth-like protrusions are sleek and smooth makes extrusion a suitable way of manufacturing.

### BRIEF DESCRIPTION OF THE DRAWINGS

FIG. 1 is a cross-sectional view of a conventional optical lens that produces a bat-wing type of lighting distribution.

FIG. 2 is a cross-sectional view of another conventional optical lens that produces a bat-wing type of lighting distribution.

FIG. 3 is a perspective view of an optical lens in accordance with a first implementation of the present invention.

FIG. 4 is a cross-sectional view of the optical lens in accordance with the first implementation of the present invention.

FIG. 5 is a cross-sectional view of a lamp having the optical lens in accordance with the first implementation of the present invention.

FIG. 6 is a perspective view of an optical lens in accordance with a second implementation of the present invention.

FIG. 7 is a cross-sectional view of the optical lens in accordance with the second implementation of the present invention.

FIG. 8 is a cross-sectional view of a lamp having the optical lens in accordance with the second implementation of the present invention.

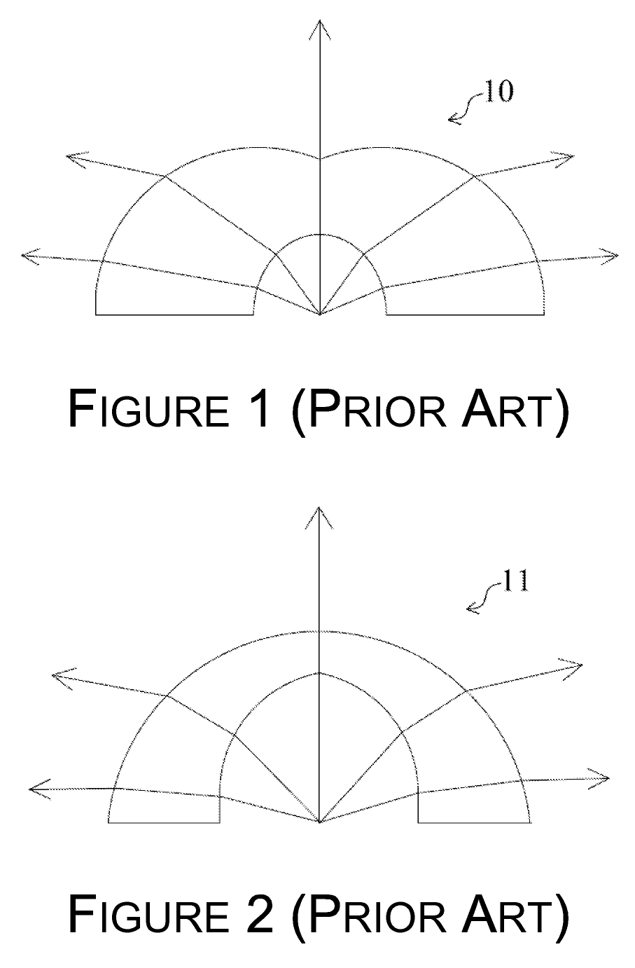

### DETAILED DESCRIPTION OF DISCLOSED EMBODIMENTS

The following description of various embodiments is provided with reference to the corresponding figures.

### First Implementation

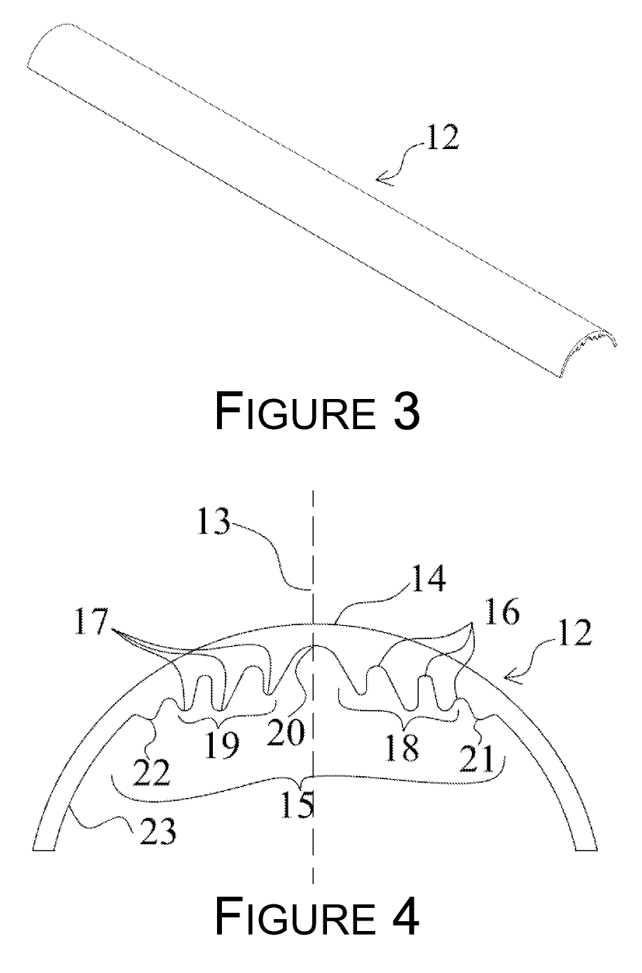

Referring to FIGS. 3 and 4, an optical lens 12 according to a first implementation of the present invention has an overall long shape with an arched cross section correspondingly having a light incident surface and a light exit surface 14. The optical lens 12 produces a bat-wing type of lighting distribution. The light incident surface comprises a sawtooth-like structure 15 having a plurality of sawtooth-like protrusions. Each of the sawtooth-like protrusions respectively comprises a peak 17, and a respective valley 16 exists between every two neighboring sawtooth-like protrusions. In one embodiment, a distance between a given valley 16 and the light exit surface 14 is approximately equal to a distance between any other valley 16 and the light exit surface 14. Alternatively, distances may be the same between some of the valleys 16 and the light exit surface 14 while some distances are different between other valleys 16 and the light exit surface 14, or the distances may be all different. The peaks 17 and the valleys 16 of the sawtooth-like protrusions are sleek and smooth. In one embodiment, a valley 16 is closer to the light exit surface 14 than a corresponding peak 17.

The light incident surface comprises a light incident surface center 20. The sawtooth-like structure 15 comprises a first group of sawtooth-like protrusions 18 and a second group of sawtooth-like protrusions 19. The first group of sawtooth-like protrusions 18 and the second group of sawtooth-like protrusions 19 are symmetrically distributed on two sides of the light incident surface center 20. An optical axis 13 of the optical lens 12 traverses through the light incident surface center 20 and a light source. A beam of light emitted by the light source is incident on the sawtooth-like structure 15 and is refracted toward the two sides of the optical axis 13 to form a bat-wing type of lighting distribution.

Each of the sawtooth-like protrusions of the sawtooth-like structure 15 forms a tilt angle between the optical axis 13 and the side of a respective sawtooth-like protrusion relatively closer to the light incident surface center 20. The tilt angle is in a range between 0° and 90°. Hereinafter the term “average angle” refers to an average of the tilt angles associated with a given group of sawtooth-like protrusions.

The first group of sawtooth-like protrusions 18 and the second group of sawtooth-like protrusions 19 are symmetrically distributed on two sides of the light incident surface center 20. In one embodiment, the respective peak of each sawtooth-like protrusion in the first group of sawtooth-like protrusions 18 and the second group of sawtooth-like protrusions 19 is tilted in a respective direction that is away from the light incident surface center 20. In one embodiment, the respective tilt angle of each sawtooth-like protrusion of the first group of sawtooth-like protrusions 18 and the second group of sawtooth-like protrusions 19 decreases correspondingly as a distance between the respective sawtooth-like protrusion and the light incident surface center 20 increases. That is, the closer a sawtooth-like protrusion is to the light incident surface center 20 the greater its respective tilt angle is, and the farther a sawtooth-like protrusion is from the light incident surface center 20 the smaller its respective tilt angle is.

The tilt angle between the optical axis 13 and the side of each sawtooth-like protrusion that is relatively closer to the light incident surface center 20 determines the beam angle of the optical lens 12. The tilt angle of each sawtooth-like protrusion of the first group of sawtooth-like protrusions 18 and the second group of sawtooth-like protrusions 19 determines the angle of deviation of the maximum light intensity from the optical axis 13, which is referred to as the beam angle herein. In some embodiments, because the first group of sawtooth-like protrusions 18 and the second group of sawtooth-like protrusions 19 are symmetrically distributed on two sides of a vertical axis of the light incident surface center 20, an analysis of an average angle of the tilt angles of the first group of sawtooth-like protrusions 18 is sufficient to show the relationship between the tilt angle of each sawtooth-like protrusion and the beam angle of the optical lens 12. As the average angle of the tilt angles of the first group of sawtooth-like protrusions 18 increases the beam angle of the optical lens 12 correspondingly decreases. As the average angle of the tilt angles of the first group of sawtooth-like protrusions 18 decreases the beam angle of the optical lens 12 correspondingly increases. The beam angle of the optical lens 12 decreases when the tilt angle of each sawtooth-like protrusion of the first group of sawtooth-like protrusions 18 and the second group of sawtooth-like protrusions 19 with respect to the optical axis 13 increases. Contrarily, the beam angle of the optical lens 12 increases when the tilt angle of each sawtooth-like protrusion of the first group of sawtooth-like protrusions 18 and the second group of sawtooth-like protrusions 19 with respect to the optical axis 13 decreases. Thus, the beam angle of the optical lens 12 is mainly determined by the first group of sawtooth-like protrusions 18 and the second group of sawtooth-like protrusions 19.

The optical lens 12 further comprises a third group of sawtooth-like protrusions 21 disposed adjacent to the first group of sawtooth-like protrusions 18 and a fourth group of sawtooth-like protrusions 22 disposed adjacent to the second group of sawtooth-like protrusions 19. In one embodiment, the respective peak 17 of each sawtooth-like protrusion of the third group of sawtooth-like protrusions 21 and the fourth group of sawtooth-like protrusions 22 is tilted in a respective direction that is away from the light incident surface center 20. In one embodiment, the respective tilt angle of each sawtooth-like protrusion of the third group of sawtooth-like protrusions 21 and the fourth group of sawtooth-like protrusions 22 increases correspondingly as a distance between the respective sawtooth-like protrusion and the light incident surface center 20 increases. The third group of sawtooth-like protrusions 21 are farther away from the optical axis 13, and the light incident surface center 20, than the first group of sawtooth-like protrusions 18 are, and the fourth group of sawtooth-like protrusions 22 are farther away from the optical axis 13, and the light incident surface center 20, than the second group of sawtooth-like protrusions 19 are.

The third group of sawtooth-like protrusions 21 and the fourth group of sawtooth-like protrusions 22 adjust distribution of light intensity of the bat-wing shape of lighting. Moreover, the third group of sawtooth-like protrusions 21 and the fourth group of sawtooth-like protrusions 22 play a transitional role structurally for the optical lens 12, from having sawtooth-like protrusions (i.e., the first group of sawtooth-like protrusions 18 and the second group of sawtooth-like protrusions 19) to having no sawtooth-like protrusions at a portion 23 of the optical lens 12. Given that the beam angle of the optical lens 12 is mainly determined by the first group of sawtooth-like protrusions 18 and the second group of sawtooth-like protrusions 19, in some applications the third group of sawtooth-like protrusions 21 and the fourth group of sawtooth-like protrusions 22 may be unnecessary and do not exist while in other applications they may be utilized.

As described above, the distances between the light exit surface 14 and the valleys 16 between every respective two neighboring sawtooth-like protrusions are approximately equal. Accordingly, the sawtooth-like structure 15 is equivalent to extending a portion of the material on an internal side of an arch-shaped material. As the uniformity of the thickness of the arch-shaped material is basically not changed, extrusion method can be used for the manufacturing thereof.

Further, each peak 17 and each valley 16 is sleek and smooth. This is favorable to manufacturing by the extrusion method. In the extrusion process, molten plastic is full of the flow path of the nozzle and is squeezed out evenly. The cavity of the nozzle is typically smooth and streamlined to reduce drag, and as a result the extrusion process cannot produce products with sharp edges and corners.

Although, as described above, the first group of sawtooth-like protrusions 18 and the second group of sawtooth-like protrusions 19 are symmetrical and the tilt angle of a sawtooth-like protrusion in the first group of sawtooth-like protrusions 18 is the same as the tilt angle of a sawtooth-like protrusion in the second group of sawtooth-like protrusions 19, the first group of sawtooth-like protrusions 18 and the second group of sawtooth-like protrusions 19 may be unsymmetrically distributed when there is a need for unsymmetrical bat-wing type of lighting distribution. For example, the average angle of the first group of sawtooth-like protrusions 18 may be different from the average angle of the second group of sawtooth-like protrusions 19, and a quantity of the sawtooth-like protrusions in the first group of sawtooth-like protrusions 18 may be different from a quantity of the sawtooth-like protrusions in the second group of sawtooth-like protrusions 19. Additionally or alternatively, the sawtooth-like protrusions in a given group of sawtooth-like protrusions may be the same. Additionally or alternatively, the tilt angle of each sawtooth-like protrusion in a given group of sawtooth-like protrusions may be the same. The rate in which the tilt angles of the sawtooth-like protrusions in a given group of sawtooth-like protrusions change may be the same as or different from the rate in which the tilt angles of the sawtooth-like protrusions in another group of sawtooth-like protrusions change, where “rate” is a measure of the magnitude of change from the tilt angle of a given sawtooth-like protrusion to the tilt angle of a neighboring sawtooth-like protrusion. By making adjustment to the quantity of the sawtooth-like protrusions, the tile angles, and rate in which the tilt angles change from one sawtooth-like protrusion to the next, and the average angle, the beam angle of the optical lens 12 and the symmetry in lighting distribution may be adjusted according to the need of the type of lighting.

As the third group of sawtooth-like protrusions 21 and the fourth group of sawtooth-like protrusions 22 play a transitional role, adjustment may be made to the quantity of the sawtooth-like protrusions, the tile angles, and rate in which the tilt angles change from one sawtooth-like protrusion to the next, and the average angle of the third group of sawtooth-like protrusions 21 and the fourth group of sawtooth-like protrusions 22 depending on the situation with the first group of sawtooth-like protrusions 18 and the second group of sawtooth-like protrusions 19. Additionally or alternatively, the third group of sawtooth-like protrusions 21 and the fourth group of sawtooth-like protrusions 22 may be unsymmetrically distributed. Additionally or alternatively, the average angle of the third group of sawtooth-like protrusions 21 may be different from the average angle of the fourth group of sawtooth-like protrusions 22. Additionally or alternatively, a quantity of third group of sawtooth-like protrusions 21 may be different from a quantity of the fourth group of sawtooth-like protrusions 22.

In some embodiments, heights of the sawtooth-like protrusions of the sawtooth-like structure 15 may be different, and may be adjusted according to the need of the type of lighting. The location of the light source may not necessarily be aligned with the optical axis 13, and may be adjusted according to the need of the type of lighting.

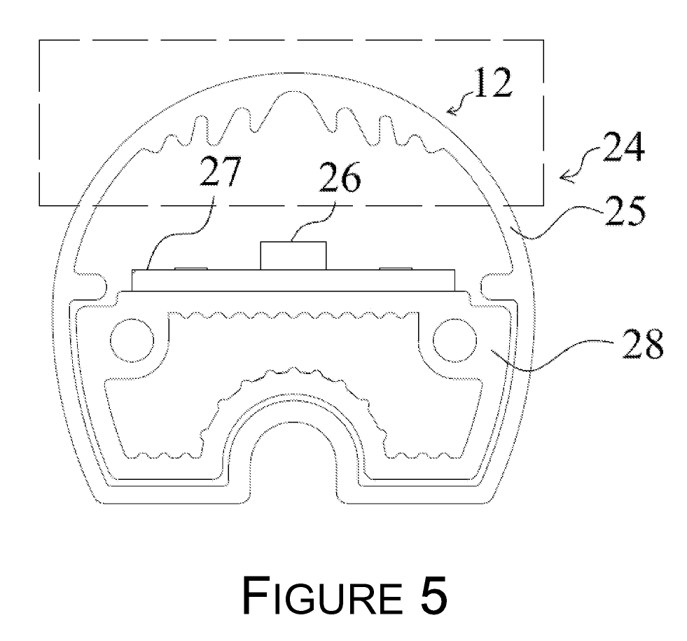

Referring to FIG. 5, a lamp 24 comprising the optical lens 12 of the first implementation is provided. The lamp 24 comprises a lamp shell 25 having an overall long shape, a light source device 26 disposed inside the lamp shell 25, a heat dissipation device 28 disposed under the light source device 26 and inside the lamp shell 25, and a circuit module 27. A cross section of the lamp shell 25 is generally in a ring shape, comprising an upper portion and a lower portion. The upper portion of the lamp shell 25 comprises the optical lens 12. The lower portion of the lamp shell 25 is used for placement of the heat dissipation device 28 and the circuit module 27. The light source device 26 is disposed near the center of the lamp shell 25. The light source device 26 is disposed on and electrically coupled to the circuit module 27, and faces the light incident surface of the optical lens 12. The circuit module 27 is disposed on the heat dissipation device 28, which is thermally coupled to the lamp shell 25. The optical lens 12 of the lamp shell 25 corresponds to the light source device 26 and, in particular, the sawtooth-like protrusion structure 15 of the optical lens 12 corresponds to the light source device 26.

### Second Implementation

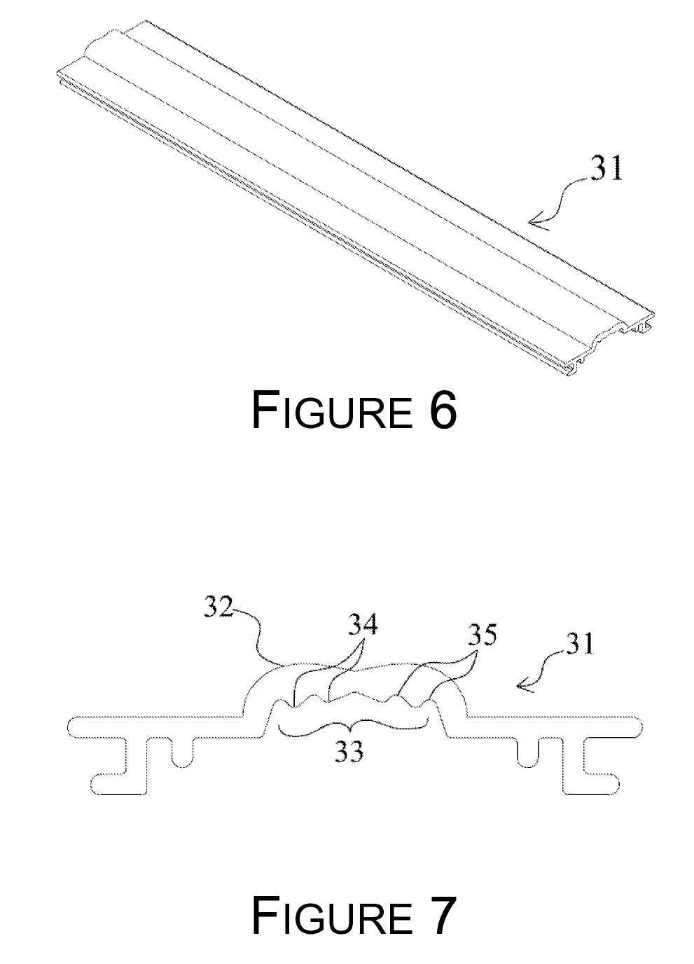

Referring to FIGS. 6 and 7, an optical lens 31 according to a second implementation of the present invention has an overall long shape with a flat cross section correspondingly having a light incident surface and a light exit surface 32. The optical lens 31 produces a bat-wing type of lighting distribution. The light incident surface comprises a sawtooth-like structure 33 having a plurality of sawtooth-like protrusions. Each of the sawtooth-like protrusions respectively comprises a peak 34, and a respective valley 35 exists between every two neighboring sawtooth-like protrusions. In one embodiment, a distance between a given valley 35 and the light exit surface 32 is approximately equal to a distance between any other valley 35 and the light exit surface 32. Alternatively, distances may be the same between some of the valleys 35 and the light exit surface 32 while some distances are different between other valleys 35 and the light exit surface 32, or the distances may be all different. The peaks 34 and the valleys 35 of the sawtooth-like protrusions are sleek and smooth.

There are several major differences between the second implementation and the first implementation of the present invention. First, the cross section of the optical lens 12 of the first implementation is arched in shape while the cross section of the optical lens 31 is flat in shape. Additionally, the optical lens 12 of the first implementation is an integral part of the lamp shell 25 while the optical lens 31 of the second implementation is separate from the lamp shell (i.e., lamp shell 45). Of course, the cross section of the optical lens of the present invention is not limited to an arched shape or a flat shape, and may be of a different shape depending on the actual need in implementation.

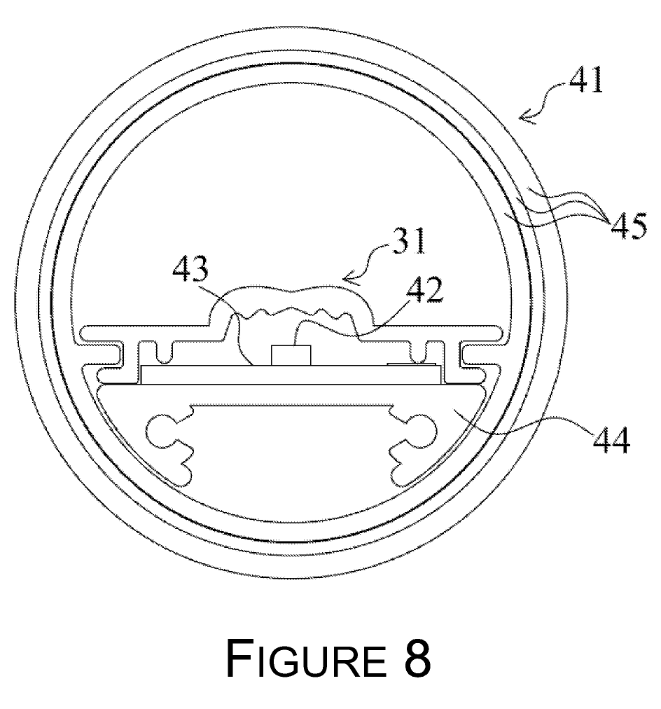

Referring to FIG. 8, a lamp 41 comprising the optical lens 31 of the second implementation is provided. The lamp 41 comprises a lamp shell 45 that has an overall long shape and a cross section of which is generally in a ring shape. The optical lens 31 is disposed inside the lamp shell 45. A light source device 42 is disposed inside the lamp shell 45 and under the optical lens 31. A heat dissipation device 44 and a circuit module 43 are disposed under the light source device 43. The light source device 42 is disposed near the center of the lamp 41. The light source device 42 is disposed on and electrically coupled to the circuit module 43, and faces the light incident surface of the optical lens 31. The circuit module 43 is disposed on the heat dissipation device 44, which is thermally coupled to the lamp shell 45. Two ends of the optical lens 31 are mortised between the circuit module 43, the heat dissipation device 44, and the lamp shell 45, such that an optical axis of the optical lens 31 is aligned corresponding to the light source device 42 and that the sawtooth-like protrusions of the optical lens 31 correspond to the light source device 42. In one embodiment, each of the two ends of the optical lens 31 further comprises a respective protrusion extending downwardly against the circuit module 43. In one embodiment, inside the lamp shell 45, the optical lens 31 is disposed between the lamp shell 45 and the light source device 42.

A beam of light emitted by the light source device 42 is incident on the light incident surface and is refracted by the sawtooth-like protrusions on the light incident surface toward the two sides of the light source device 42 to form a bat-wing type of lighting distribution. The lamp shell 43 has a uniform thickness throughout, and can protect the components disposed therein, such as the optical lens 31, light source device 42, etc.

In some embodiments, the optical lens of at least one of the first and second implementations of the present invention may include sawtooth-like protrusions some of which having the same tilt angle.

In some embodiments, the optical lens of at least one of the first and second implementations of the present invention may have sawtooth-like protrusions on one half side and no sawtooth-like protrusions on the other half side.

In some embodiments, the sawtooth-like protrusions of the optical lens of at least one of the first and second implementations of the present invention may be added onto the light incident surface as accessories or, alternatively, formed as an integral part of a one-piece optical lens.

In some embodiments, the light source device of at least one of the first and second implementations of the present invention may comprise an LED or, alternatively, another type of light source device.

In some embodiments, the lamp of at least one of the first and second implementations of the present invention may be utilized in products for indoor lighting, outdoor lighting, or backlight module applications.

The above-described examples pertain to two sample implementations of the present invention, the description of which is more specific and detailed. However, as those skilled in the art would appreciate, the scope of the present invention is not and cannot be limited to the disclosed embodiments. More specifically, one ordinarily skilled in the art may make various deviations and improvements based on the disclosed embodiments, and such deviations and improvements are still within the scope of the present invention. Accordingly, the scope of protection of a patent issued from the present disclosure is determined by the claims as follows.

What is claimed is:

1. An optical lens being overall long in shape and configured to produce a bat-wing type of lighting distribution, comprising:
a light exit surface; and
a light incident surface, the light incident surface comprising a sawtooth-like structure having a plurality of sawtooth-like protrusions, each of the sawtooth-like protrusions having a respective peak, every two neighboring sawtooth-like protrusions of the plurality of sawtooth-like protrusions forming a respective valley of a plurality of valleys including a first valley and a second valley, a first distance between the light exit surface and the first valley being approximately equal to a second distance between the light exit surface and the second valley.

2. The optical lens as recited in claim 1, wherein the respective peak of each sawtooth-like protrusion is sleek and smooth, and wherein the respective valley between every two neighboring sawtooth-like protrusions of the plurality of sawtooth-like protrusions is sleek and smooth.

3. The optical lens as recited in claim 1, wherein the light incident surface comprises a light incident surface center, wherein the plurality of sawtooth-like protrusions comprises a first group of sawtooth-like protrusions and a second group of sawtooth-like protrusions symmetrically distributed on two sides of the light incident surface center, and wherein the respective peak of each sawtooth-like protrusion of the first group of sawtooth-like protrusions and the second group of sawtooth-like protrusions is tilted in a respective direction that is away from the light incident surface center.

4. The optical lens as recited in claim 3, wherein a respective tilt angle of each sawtooth-like protrusion of the first group of sawtooth-like protrusions and the second group of sawtooth-like protrusions decreases correspondingly as a distance between the respective sawtooth-like protrusion and the light incident surface center increases.

5. The optical lens as recited in claim 3, wherein the plurality of sawtooth-like protrusions further comprises:
a third group of sawtooth-like protrusions disposed adjacent to the first group of sawtooth-like protrusions; and
a fourth group of sawtooth-like protrusions disposed adjacent to the second group of sawtooth-like protrusions,
wherein a respective peak of each sawtooth-like protrusion of the third group of sawtooth-like protrusions and the fourth group of sawtooth-like protrusions is tilted in a respective direction that is away from the light incident surface center,
wherein the third group of sawtooth-like protrusions are farther away from the light incident surface center than the first group of sawtooth-like protrusions are, and
wherein the fourth group of sawtooth-like protrusions are farther away from the light incident surface center than the second group of sawtooth-like protrusions are.

6. The optical lens as recited in claim 5, wherein a respective tilt angle of each sawtooth-like protrusion of the third group of sawtooth-like protrusions and the fourth group of sawtooth-like protrusions increases correspondingly as a distance between the respective sawtooth-like protrusion and the light incident surface center increases.

7. The optical lens as recited in claim 1, wherein a cross section of the optical lens is arched in shape or flat in shape.

8. A lamp, comprising:
a light source device;
a heat dissipation device;
a circuit module; and
a lamp shell in which the light source device, the heat dissipation device and the circuit module are disposed, the lamp shell having an overall long shape and a generally ring-shaped cross section, the lamp shell comprising an upper portion and a lower portion, the upper portion of the lamp shell comprising an optical lens having a cross section arched in shape and configured to produce a bat-wing type of lighting distribution, the optical lens including a light incident surface that faces the light source device.

9. The lamp as recited in claim 8, wherein the optical lens comprises:
a light exit surface; and
the light incident surface, the light incident surface comprising a sawtooth-like structure having a plurality of sawtooth-like protrusions, each of the sawtooth-like protrusions having a respective peak and every two neighboring sawtooth-like protrusions of the plurality of sawtooth-like protrusions forming a respective valley such that a first distance between the light exit surface and a first valley is approximately equal to a second distance between the light exit surface and a second valley.

10. The lamp as recited in claim 9, wherein the respective peak of each sawtooth-like protrusion is sleek and smooth, and wherein the respective valley between every two neighboring sawtooth-like protrusions of the plurality of sawtooth-like protrusions is sleek and smooth.

11. The lamp as recited in claim 9, wherein the light incident surface comprises a light incident surface center, wherein the plurality of sawtooth-like protrusions comprises a first group of sawtooth-like protrusions and a second group of sawtooth-like protrusions symmetrically distributed on two sides of the light incident surface center, and wherein a respective peak of each sawtooth-like protrusion of the first group of sawtooth-like protrusions and the second group of sawtooth-like protrusions is tilted in a respective direction that is away from the light incident surface center.

12. The lamp as recited in claim 11, wherein a respective tilt angle of each sawtooth-like protrusion of the first group of sawtooth-like protrusions and the second group of sawtooth-like protrusions decreases correspondingly as a distance between the respective sawtooth-like protrusion and the light incident surface center increases.

13. The lamp as recited in claim 11, wherein the plurality of sawtooth-like protrusions further comprises:
a third group of sawtooth-like protrusions disposed adjacent to the first group of sawtooth-like protrusions; and
a fourth group of sawtooth-like protrusions disposed adjacent to the second group of sawtooth-like protrusions,
wherein a respective peak of each sawtooth-like protrusion of the third group of sawtooth-like protrusions and the fourth group of sawtooth-like protrusions is tilted in a respective direction that is away from the light incident surface center,
wherein the third group of sawtooth-like protrusions are farther away from the light incident surface center than the first group of sawtooth-like protrusions are, and
wherein the fourth group of sawtooth-like protrusions are farther away from the light incident surface center than the second group of sawtooth-like protrusions are.

14. The lamp as recited in claim 13, wherein a respective tilt angle of each sawtooth-like protrusion of the third group of sawtooth-like protrusions and the fourth group of sawtooth-like protrusions increases correspondingly as a distance between the respective sawtooth-like protrusion and the light incident surface center increases.

15. A lamp, comprising:
a light source device;
a heat dissipation device;
a circuit module;
a lamp shell in which the light source device, the heat dissipation device and the circuit module are disposed, the lamp shell having an overall long shape and a generally ring-shaped cross section; and
an optical lens having a cross section flat in shape and disposed between the light source device and the lamp shell, the optical lens configured to produce a bat-wing type of lighting distribution, the optical lens including a light incident surface that faces the light source device.

16. The lamp as recited in claim 15, wherein the optical lens comprises:
a light exit surface; and
the light incident surface, the light incident surface comprising a sawtooth-like structure having a plurality of sawtooth-like protrusions, each of the sawtooth-like protrusions having a respective peak and every two neighboring sawtooth-like protrusions of the plurality of sawtooth-like protrusions forming a respective valley such that a first distance between the light exit surface and a first valley is approximately equal to a second distance between the light exit surface and a second valley.

17. The lamp as recited in claim 16, wherein the light incident surface comprises a light incident surface center, wherein the plurality of sawtooth-like protrusions comprises a first group of sawtooth-like protrusions and a second group of sawtooth-like protrusions symmetrically distributed on two sides of the light incident surface center, and wherein a respective peak of each sawtooth-like protrusion of the first group of sawtooth-like protrusions and the second group of sawtooth-like protrusions is tilted in a respective direction that is away from the light incident surface center.

18. The lamp as recited in claim 17, wherein a respective tilt angle of each sawtooth-like protrusion of the first group of sawtooth-like protrusions and the second group of sawtooth-like protrusions decreases correspondingly as a distance between the respective sawtooth-like protrusion and the light incident surface center increases.

19. The lamp as recited in claim 17, wherein the plurality of sawtooth-like protrusions further comprises:
a third group of sawtooth-like protrusions disposed adjacent to the first group of sawtooth-like protrusions; and
a fourth group of sawtooth-like protrusions disposed adjacent to the second group of sawtooth-like protrusions,
wherein a respective peak of each sawtooth-like protrusion of the third group of sawtooth-like protrusions and the fourth group of sawtooth-like protrusions is tilted in a respective direction that is away from the light incident surface center,
wherein the third group of sawtooth-like protrusions are farther away from the light incident surface center than the first group of sawtooth-like protrusions are, and
wherein the fourth group of sawtooth-like protrusions are farther away from the light incident surface center than the second group of sawtooth-like protrusions are.

20. The lamp as recited in claim 19, wherein a respective tilt angle of each sawtooth-like protrusion of the third group of sawtooth-like protrusions and the fourth group of sawtooth-like protrusions increases correspondingly as a distance between the respective sawtooth-like protrusion and the light incident surface center increases.
